(19) United States
(12) Patent Application Publication
(10) Pub. No.: US 2017/0270596 A1
(43) Pub. Date: Sep. 21, 2017

(54) Procurement System with Approval Mechanisms for Improving Procurement Cycle Efficiency

(71) Applicant: Global eProcure, Clark, NJ (US)

(72) Inventor: Dhananjay Nagalkar, Bridgewater, NJ (US)

(21) Appl. No.: 15/170,287

(22) Filed: Jun. 1, 2016

Related U.S. Application Data
(63) Continuation-in-part of application No. 15/073,067, filed on Mar. 17, 2016.

(51) Int. Cl. G06Q 30/06

(52) U.S. Cl. CPC G06Q 30/0637

(57) ABSTRACT

Example embodiments disclose a method for managing a requisition. In example embodiments the method includes using an electronic interface to define a first requisition and checking a name of a requisitioner to determine whether the requisitioner has previously submitted a requisition. In one nonlimiting example embodiment requisitioner has not previously submitted a requisition a list of approvers is sent a notification and the response times of the approvers are tracked. If the name has been previously submitted the system fetches approval related data from a historical knowledge base.

### CROSS REFERENCE PARAGRAPH

This application is a continuation in part of U.S. patent application Ser. No. 15/073,067 filed on Mar. 17, 2016, the entire contents of which is herein incorporated by reference.

### BACKGROUND

1. Field

Example embodiments relate to a procurement system with approval mechanisms for improving procurement cycle efficiency.

2. Description of the Prior Art

Organizations have been adopting electronic procurement systems with an intention to optimize the process of purchasing goods or services required for their operations. Many of the electronic procurement systems automate and enable typical procurement process activities. While the systems enable procurement process as a whole, the steps requiring human intervention to complete the procurement activities, such as approvals of transactions, is a potential risk area in terms of increasing the procurement cycle time. This often leads to operational inefficiencies. An inefficient procurement process can have far reaching effects across an organization.

Many of the procurement systems include a setup of various approval mechanisms covering single point approvals, multipoint approvals, as well as header level and line item level approvals of transactions. Also many of the systems provide a facility for the approvers to delegate their approval responsibility to another approver as needed.

Prior art purchasing processes typically involve a buyer creating requisitions or orders. These requisitions or orders are often approved by a group of approvers before an order is issued to a supplier. The cycle time of procurement then depends on cycle time required for the approval of the transactions, however, conventional systems lack visibility when the transaction is routed for approval. Another challenge faced today is that when an existing approver delegates responsibility to another approver, the increased work load on the delegated user has a direct impact on the approval cycle time. The prevailing arts related to approval mechanisms (Reference: Line item approval processing system—U.S. patent application Ser. No. 10/099,697 and System and Method for Approval and allocation of cost—U.S. patent application Ser. No. 12/848,403) are limited as there is no opportunity for the users to proactively reduce the cycle time.

### SUMMARY

Example embodiments disclose novel requisition approval systems. The requisition systems may include at least three different mechanisms which may help a user/requisitioner expedite approvals. The new systems provide flexibility to buyers and approvers. The approval systems employ an artificial intelligence based approval engine which may: a) provide visibility to estimated approval cycle time to user/requisitioners based on the requisition content and allow an option for expedited approval; b) provide a mechanism for proxy approval where an approver can setup pre-approvals based on requisition parameters and rules in anticipation of specific requisition from a buyer; and c) allow tiered approval delegation through which an approver can delegate approving rights based on dollar amount and category.

In at least one example embodiment a manager may choose to designate his or her authority to approve requisitions to other personnel of their choosing. This may be done through tiered delegation. In this nonlimiting example embodiment an approver may delegate authority by dollar amount or by category. When the designee is chosen, all requisitions awaiting action may show up in the designee's queue when they log on to the system.

Intelligent approval systems in accordance with example embodiments may help a user/requisitioner expedite approval time. In at least one example embodiment, while creating requisition or purchase order and submitting it for approval, an AI based algorithm may display average approval time taken by a particular approver (or approvers) based in historical data analysis. If the user/requisitioner requested production or service and an estimated time for approval indicates the production or service requisition order will not be approved before a deadline, the system gives an option to add central approval that have highest authority to approve.

The following are some use cases in which the inventor's procurement system provides advantages over the prior art. On providing the “need by date”, the estimated approval date is provided and the inventor's system recommends the request be marked as an expedited request or ask for expedited shipping. In case of pool approvals, pick the approval chain based on availability of the approvals and other parameters. Approver can be provided with guidance on whether a particular category, dollar amount or a particular user is autoapproved or delegated

In example embodiments, the Approval time functionality may allow a user/requisitioner to reduce procurement cycle time. The approval time functionality in example embodiments may be realized by using an artificial intelligence based knowledge base of approval flow and average approval time. The basis of this knowledge base may be cost center/Profit center and category. The basis has been set so because of the fact that as per the industry practice, HR hierarchy based or category based approval or both together is required for an approval on requisition.

In one example embodiment a user/requisitioner enters a requisition for approval in requisition approval system. The system picks up timelines from an existing knowledgebase and calculates the estimated average time required for the requisition to get approved based on the below logic. This may provide the user/requisitioner an estimate on the time a requisition would take to get approved by all the approvers in the queue. Calculating the approval timeline for the approval chain based on Requester name, Category, Requisition line item, Past request approved by approver of same user, Unit price, and Total price.

In example embodiments a requisition or purchase order may be filled out by a user/requisitioner and an AI based engine may check above mentioned parameters and give projected approval time for that particular request. The system may also check historical approval trend between requestor and approver. (i.e. —Out of past 10 requisition submitted by user 8 or 10 is approved by approver then new requisition is most likely to get approved. If only 2-4 requisition is approved then new approval might take long time to approve because proper due diligence is required by approver). Based on user/requisitioner name and requisition category, system will decide line of approval required for requisition to get approved. Requisition line item, unit price and total price parameter may be used by system to check historic approval trend from knowledge base.

Example embodiments also provide a system that provides the best and worst timeline estimate for the approval flow. As the system may be AI based, it may keep on learning and may update it's knowledge based constantly. Based upon the learning, approvers whose timelines are above a predefined threshold may get tagged as bottle neck approvers. These bottle necks may be highlighted to a user/requsitioner enabling him/her to use an expedited approval feature if required.

In example embodiments bottleneck approvers may be identified by a system. When the business user/requisitioner place the requisition for approval the approval flow may include the bottleneck approvers and the list of the bottleneck approvers may be displayed to the business user/requisitioner. So even if the business user/requisitioner has placed the requisition for approval then also he/she may bypass these bottleneck approvers. He/she, for example, may redirect the approval flow to a list of lead approvers.

In example embodiments, an expedited approval may allow a user/requisitioner to quicken his approval timeline by adding additional lead approver to approve the requisition. This lead approver may have relatively high authority to approve any requisition. An original approver to whom an original request was submitted may get notified that particular requisition has been routed to lead approver to expedite approval.

### BRIEF DESCRIPTION OF THE DRAWINGS

The disclosure will be better understood and when consideration is given to the drawings and the detailed description which follows. Such description makes reference to the annexed drawings wherein:

FIG. 1 is a view of a requisition approval system in accordance with example embodiments;

FIG. 2 is a view of a approver list in accordance with example embodiments;

FIG. 2 is a view of a method in accordance with example embodiments;

FIG. 3 is a view of a method in accordance with example embodiments;

FIG. 4 is a view of a method in accordance with example embodiments;

FIG. 5 is a view of a method in accordance with example embodiments;

FIG. 6 is a view of a method in accordance with example embodiments;

FIG. 7 is a view of a method in accordance with example embodiments;

FIG. 8 is a view of a method in accordance with example embodiments; and

FIG. 9 is a view of a method in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another elements, component, region, layer, and/or section. Thus, a first element component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a procurement system with approval mechanisms for improving procurement cycle efficiency.

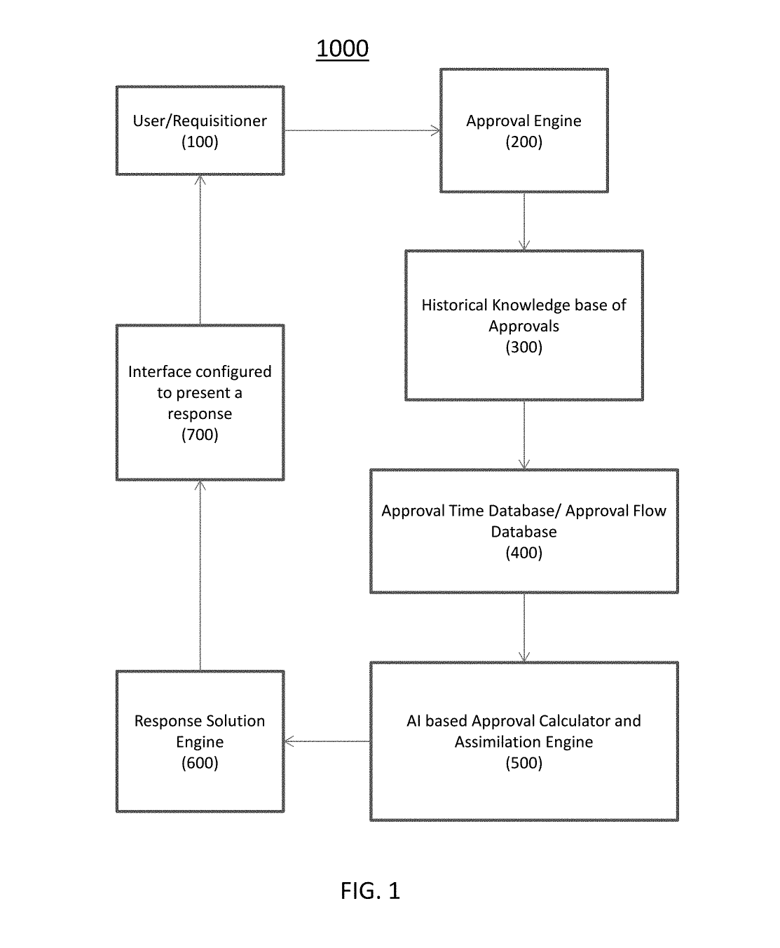

FIG. 1 is a view of a requisition approval system 1000 in accordance with example embodiments. As shown in FIG. 1, the requisition approval system 1000 may include an approval engine 200, a historical knowledge base of approvals 300, an approval time database/approval flow database 400, an AI based approval calculator and assimilation engine 500, a response solution engine 600, and an interface 700 configured to allow a user/requisitioner 100 to enter a requisition into the system 1000 and/or present a response from the system 1000 to the user/requisitioner 100. In example embodiments the interface 700 may be a computer interface, for example, a computer terminal, an I-Pad, or a smart phone. The interface 700 may also be configured to provide information to the user/requisitioner 100 regarding the approval process and may assist the user/requisitioner 100 in controlling the approval process.

In example embodiments the system 1000 may store data and rules which may be usable for controlling how the system 1000 regulates a requisition approval. For example, the system 1000 may store data and rules which control how many approvers are necessary to approve a requisition. For example, a company using the system 1000 may decide that some business units within the company may require only a single approver whereas other business units may require more than one approver. A category of good may also determine how many approvers are required. For example, some categories of goods may require only a single approver whereas other categories of goods may require more than one approver. As yet another example, a dollar amount associated with a requisition or purchase order may determine how many approvers are required to approve a requisition or purchase order. For example, if the dollar amount is below a first preset value only a single approver may be required whereas if the first preset value is exceeded more than one approver may be required. Of course, in example embodiments, several approvers may be required based on the dollar amount. For example, if the purchase order is less than the first preset value the number of approvers may be one. If the purchase order is greater than the first present value but less than a second preset value the number of approvers may be two. If the purchase order is greater than the second preset value but less than a third preset value, then the number of approvers may be three, and so on. As yet another example, the number of approvers necessary to approve a purchase or requisition order may be a function of the business unit, the category of item being purchased, and the dollar amount to be purchased. Regardless, in example embodiments the system 1000 may be configured so that a number of approvers may be determined based on a set of rules, nonlimiting examples of which are provided above.

In example embodiments the system 1000 may store data and rules which may be usable for controlling what type of approval is required for a requisition or purchase order. For example, in this application, approval of a requisition or purchase order may be either “parallel” or “pool.” “Parallel” approval simply means that in order for a purchase order or a requisition order to be approved it must be approved by all approvers assigned to approve the requisition or purchase order. “Pool” approval, on the other hand, simply means that only one approver among a plurality of approvers is required to approve a requisition or purchase order. For example, a company using the system 1000 may decide that some business units may require “parallel” approval whereas other business units may require “pool” type approval. A category of good may also determine whether an approval type is “pool” or “parallel.” For example, some categories of goods may require “parallel” approval whereas other categories of goods may require “pool” type approval. As yet another example, a dollar amount associated with a requisition or purchase order may determine whether an approval type is “pool” or “parallel.” For example, if the dollar amount is below a first preset value only a “pool” type approval is necessary whereas if the first preset value is exceeded a “parallel” type approval is necessary. As yet another example, approval type may be a function of the business unit, the category of item being purchased, and the dollar amount to be purchased.

Thus far, in example embodiments, it is understood that an approval of a requisition or purchase order may require a “pool” type approval or a “parallel” type approval. Whether it is a “pool” or “parallel” type of approval will depend on certain rules that may be established by a company. Similarly, approval of a requisition or purchase order may be authorized by one or more approvers, the number of which is also determined by rules established by a company using the system 1000. As for approvers, approver identities may be recorded identified and stored in an electronic database. The names of the approvers may be recorded along with various characteristics of the approvers. For example, the system may record the names of approvers, contact information for the approvers, for example, email addresses and phone numbers, the business units for which the approver may approve a requisition or purchase order, as well as whether or not the approver has delegated any of his to duties to another person. The system 1000 may also provide historical information for each approver. The historical information may include information such as, but not limited to, average length of time it takes for an approver to approve a requisition or purchase order. Additional historical data may also be available via the historical knowledge base of approvals 300. For example, the historical knowledge base of approvals 300 may include statistical information such as an average length of time it takes for an approver to approve a requisition or purchase order along with standard deviations, median numbers, and modes associated with approving requisitions. This data may be helpful in predicting how long an approver may take in approving a requisition. This data may be recorded in single database or across several databases. For example, all or some of this information may be recorded in the historical knowledge base of approvals 300.

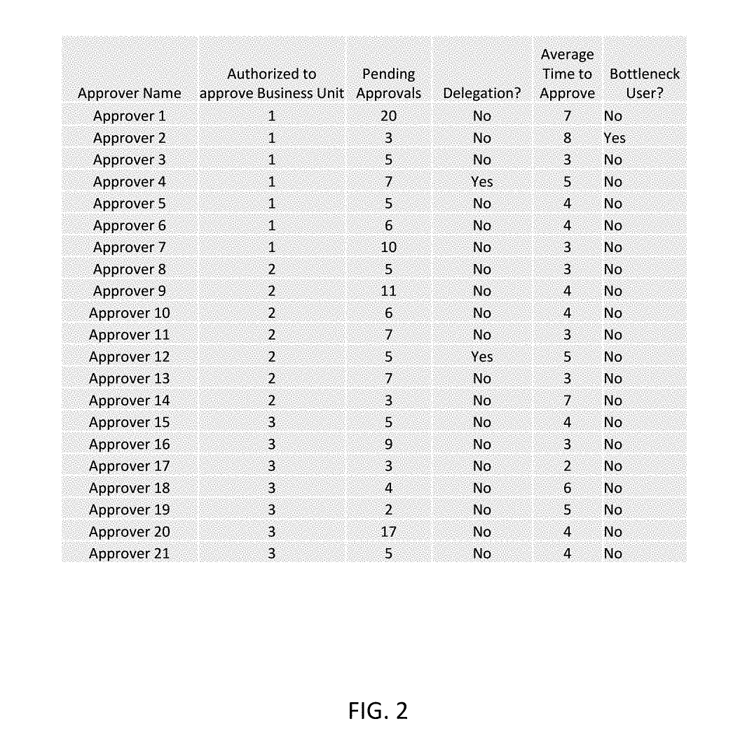

FIG. 2 provides an example of a list which may be maintained in an electronic database of system 1000. The example list of FIG. 2, includes the names of twenty one approvers cross-referenced with the following information: the business unit the approver is authorized to provide approval for, the number of approvals pending in the approver's task list, whether or not the approver has delegated his work to another party, historical data regarding time approver takes to approve a requisition or purchase order (for example, average length of time to approve requisition, standard deviation, etc.), and whether the user is a bottleneck user. Although FIG. 2 illustrates this data is maintained in one electronic database, the invention is not limited thereto as the data may be maintained in different electronic databases. In addition, the table may include additional data. For example the table may include other statistical information such as, but not limited to, standard deviations associated with the time it takes an approver to approve a requisition or purchase order. Also, in some embodiments, the list of approvers is not required to have all of the data illustrated in FIG. 2. For example, the list may not provide data regarding which business unit the approver is authorized to provide approvals for.

In example embodiments the system 1000 may utilize historical records and artificial intelligence in order to improve and/or enhance requisition approval. The historical records may be recorded in the historical knowledge base of approvals 300. The historical records, for example, may be related to approval performance and times of one or more approvers and the system 1000 may use this data to predict how a requisition may be treated in the system 1000.

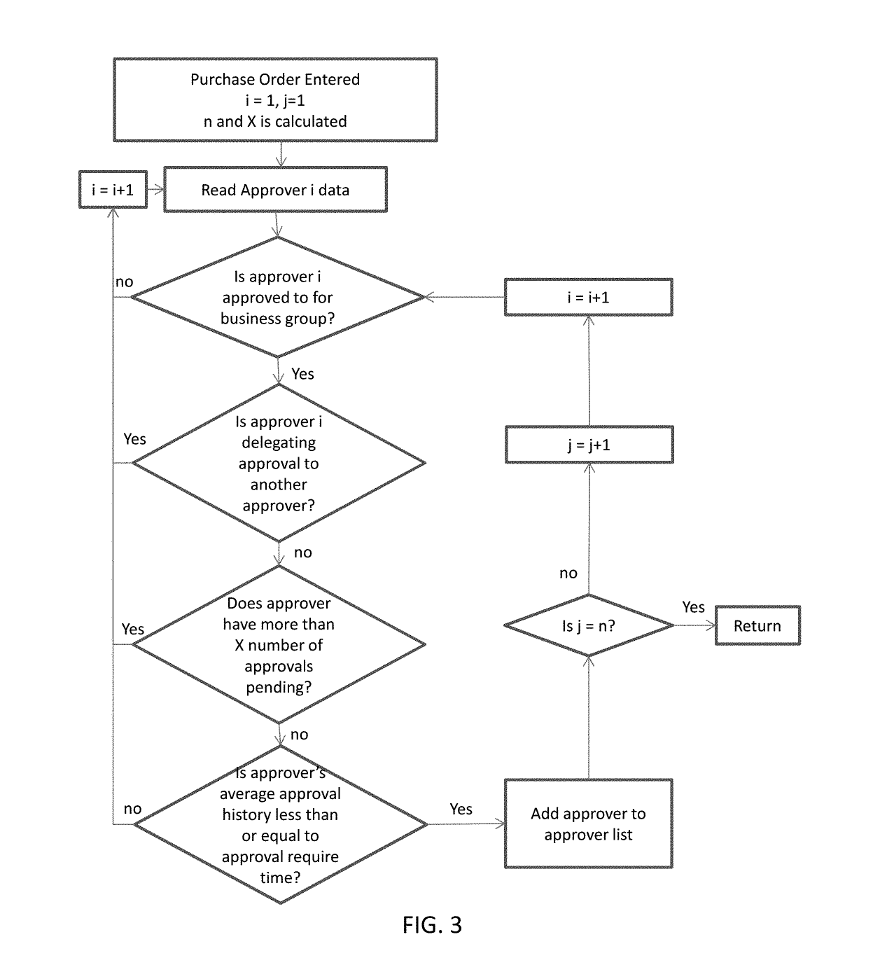

FIG. 3 is a view of a method the system 1000 may implement in order to determine a list of approvers for a requisition or purchase order. In FIG. 3, the method may begin when a user enters a requisition or purchase order into the system 1000. Once entered the system 1000 may determine, based on various parameters of the purchase order, for example, the business unit and/or the total cost associated with the purchase order, the number of approvers n that are required to approve the requisition or purchase order (based on the aforementioned rules and data). The system 1000 may then read the electronic database and search for the appropriate approvers. The appropriate users may, for example, be approvers that are approved to authorize requisition or purchase order for a particular business group, has not delegated his authorization to another approver, has fewer than a predetermined number of approvals X on his or her worklist, and has a history which is indicative of being able to complete an approval within a time designated in the requisition or purchase order. It is understood that the list may also not include all of the information illustrated in FIG. 2. For example, the list may not include the business unit the approver is authorized to approve requisition or purchase orders for.

For purposes of clarity an example of producing an approver list is provided. For example, suppose a user/requisitioner 100 provided a requisition order to the system 1000. Suppose further the requisition order is for business group 2 and required approval time is 3 days or less. Suppose further the system 1000 was configured so that group 2 requisitions require two approvers and that the approver cannot have more than 10 approvals pending. The system 1000, as illustrated in FIG. 3, would determine n=2 and X=10 as provided for by the aforementioned rules. The system 1000 would then cycle through the approver list of FIG. 2. Because the requisition order was for business group 2 the system 1000 would ignore the first seven approvers (Approver 1, Approver 2, Approver 3, Approver 4, Approver 5, Approver 6, and Approver 7) of the approver list. However, at Approver 8 the system would determine Approver 8 is eligible for approval since Approver 8 may approve requisition and purchase orders for Business Unit 2. The system would then determine whether the Approver has delegated his/her responsibilities to another party. In this case Approver 8 has not, as such, Approver 8 is still a candidate. The system would then determine how may approvals Approver 8 had pending. In this case Approver 8 has five approvals pending and therefore is still a candidate approver since five approvals is less than the maximum approvals Approver 8 may have. Finally, the system would determine whether Approver 8's historical information supports the notion Approver 8 may approve the order within 3 days. In this case the system 1000 would determine that Approver 8 is still a candidate and therefor adds Approver 8 to system 1000's approver list. The system 1000 would then look to the next candidate, Approver 9, and walk through the same steps. However, because Approver 9 has eleven pending approvals, Approver 9 would not be added to the approver's list. The system 1000 would then look at the next candidate, Approver 10, and walk through the above steps. However, because candidate 10 typically takes four days to approve a requisition order, candidate 10 would not be added to the approver's list. The system 1000 would then look at the next candidate, candidate 11, and would repeat the following steps. Candidate 11, however, does satisfy the above criteria and therefore would be added to the approver's list thus terminating the process.

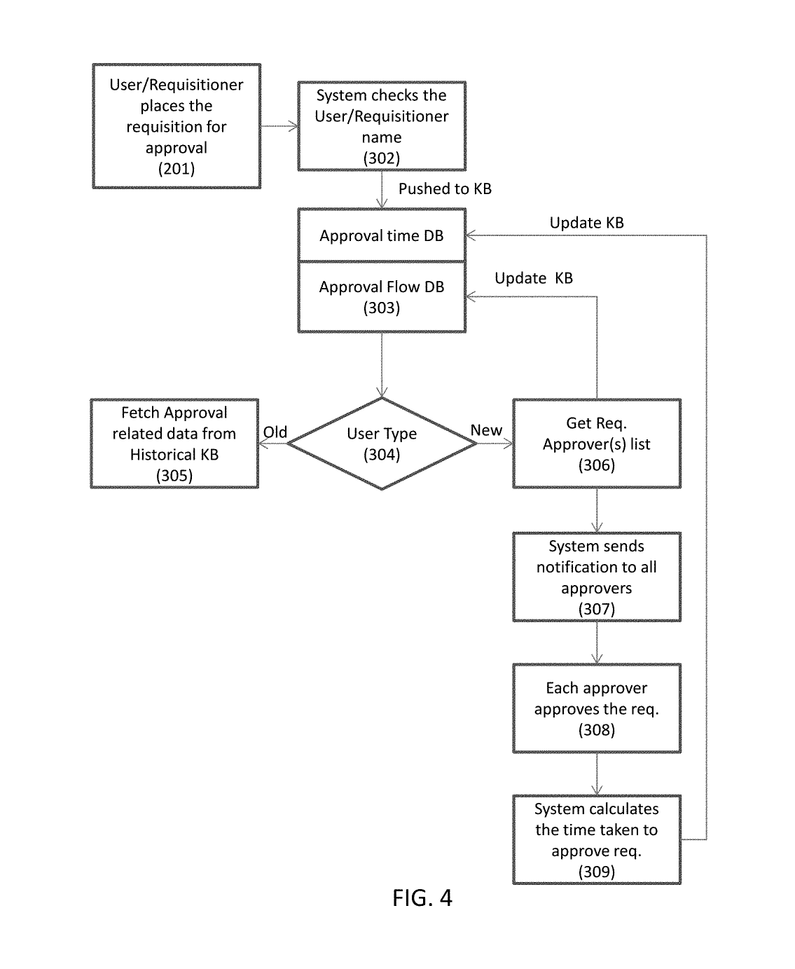

In example embodiments, the system 1000 may be configured to collect and/or store historical data of approvers tasked with approving a requisition. FIG. 4, for example, illustrates operations associated with an example method for collecting and/or storing approver data. In this example, approver data may be collected by the system 1000 and recorded in an approval time database and an approval flow database of the approval time database/approval flow database 400. As shown in FIG. 4 the method may begin with a user/requisitioner 100 placing a requisition for approval in the system 1000 (see operation 201). The requisition may include various types of information. For example, a requisition may include information such as, but not limited to, the user's name, a category for a good, the department requesting a material, a requisition line item, the exact number of supplies requested, a description of the supplies, a name of the supplier, the expected purchase price for the supplies (both unit prices and total prices), and a target date for which approval is required. In the nonlimiting example embodiment of FIG. 4, a user/requisitioner 100 places his or her requisition for approval in the system 1000 and the system 1000 checks the name of the user/requisitioner 100 to determine whether the user/requisitioner 100 is new to the system or old to the system (see operation 302). If the user is new to the system 1000 the system 1000 generates a list of approvers for the user/requisitioner's requisition (see operation 306) and notifies each of the approvers of the pending requisition (see operation 307). The list of approvers may be generated by a method similar to that of FIG. 3 (except this method would not include the step of determining whether an approver's average approval history is less than or equal to approval time required) and the list is pushed to the approval flow database to populate the approval flow database. The system 1000 may then record information related to each approver as the approver approves the requisition (see operation 308). The system 1000 may, for example, record the times it took for each approver to approve the requisition (see operation 309). This data is pushed to the approval time database to populate the approval time database. In some cases, if the time it took for an approver to approve a requisition exceeds a predetermined amount of time, the approver may be tagged as a “bottleneck.” Knowing which approvers are “bottlenecks” may help a user user/requisitioner 100 manage the system 1000 as illustrated below.

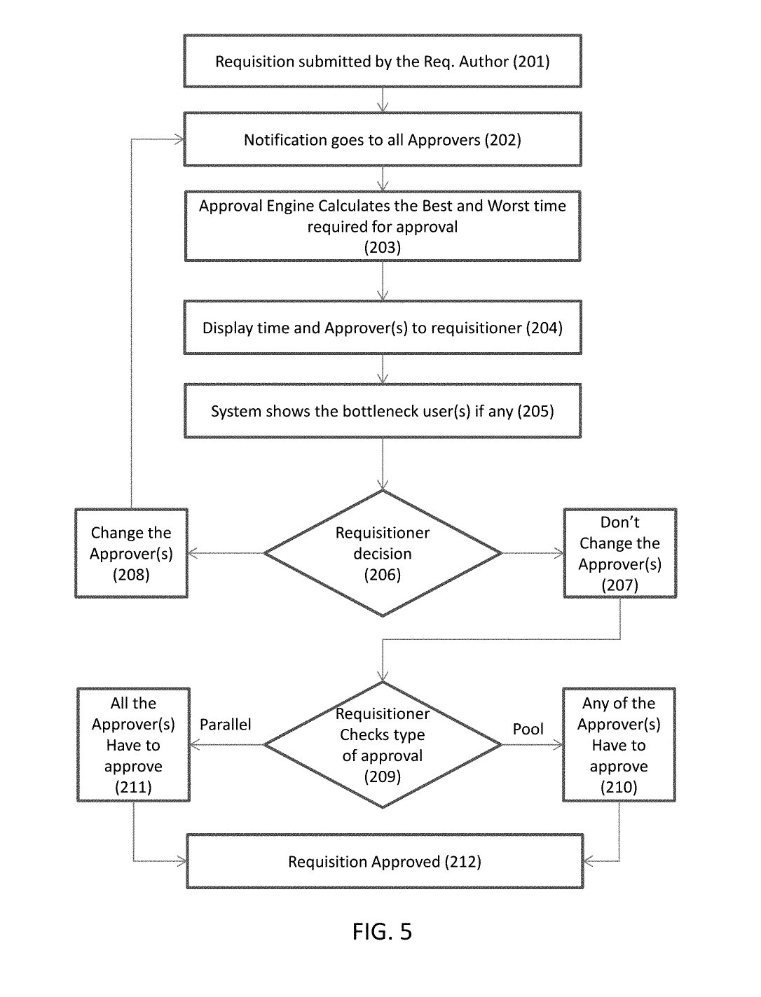

FIG. 5 illustrates how a user may partially manage a requisition process. In FIG. 5 the user/requisitioner 100 places his or her requisition for approval in the system 1000. In this nonlimiting example embodiment, the system 1000 checks the name of the user/requisitioner 100 to determine whether the user/requisitioner 100 is new to the system or old to the system 1000. If the user/requisitioner 100 is new to the system 1000 the system may operate as illustrated in FIG. 4, however, if the user/requisitioner 100 is old to the system 1000 then the system 1000 may operate as illustrated in FIG. 5.

In FIG. 5 the approval engine 200 may generate a list of approvers as shown in FIG. 3. Of course, this step may include pulling historical data from the historical knowledge base of approvals. After the list of approvers is determined the system 1000 may send a notification to the approvers (see operation 202). For example, the system 1000 may send an email notification to each of the approvers. Because the historical knowledge base of approvals 300 may include records related to the list of approvers and information regarding how long the approvers take to approve a requisition, the approval engine 200 may calculate best and worst times required for approval and report which approvers may bottleneck the approval process. In example embodiments, this information may be displayed to the user/requisitioner 100 (see operations 203, 204, and 205) and the user/requisitioner 100 may decide whether to change approvers. If so, the system may generate a new list of approvers (see operation 208) and the system 1000 may repeat the above steps for the new list of approvers. In the alternative, the user/requisitioner may simply forward his requisition order to a master approver for approval. If the user/requisitioner 100 decides not to change the approvers, the system 1000 may determine whether or not to approve the requisition based on the action of the approvers and the type of requisition. For example, if the requisition requires parallel approval the system 1000 will not approve the requisition until all of the approvers have approved the requisition. However, if the requisition type requires pool approval, then the system 1000 will approve the requisition after any one of the approvers have approved the requisition. Whether or not an approval is required to be a “pool” approval or a “parallel” approval may be determined by various rules as explained above.

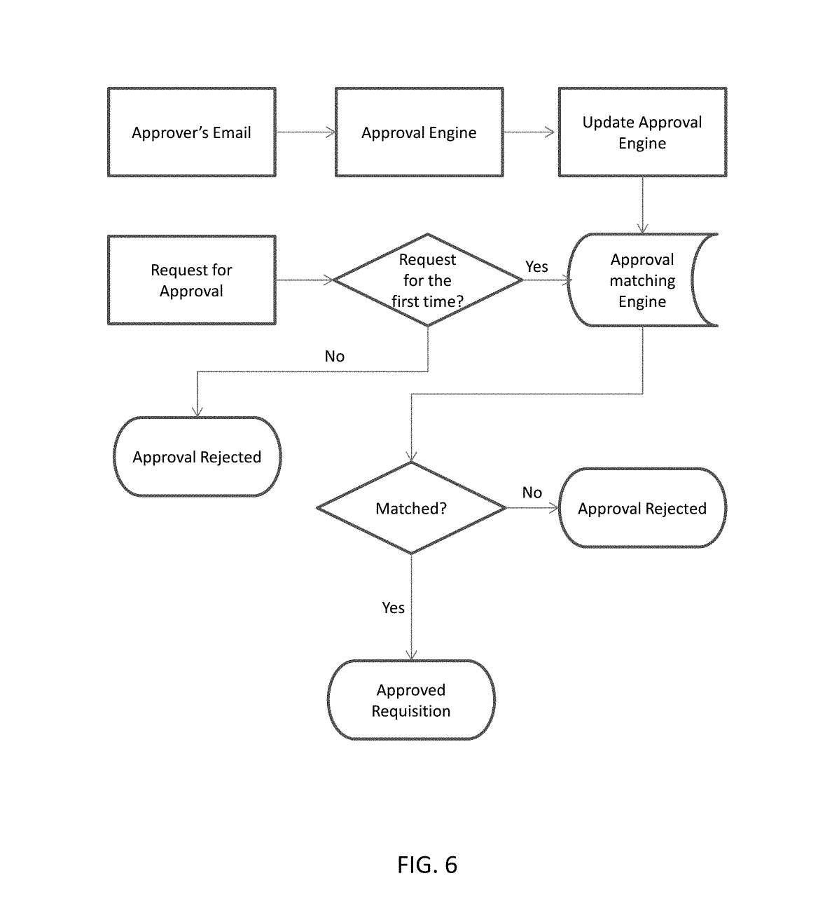

In example embodiments, the system 1000 may be further configured to allow approval of a requisition by proxy. FIG. 6, for example, illustrates an example of one embodiment of a proxy feature associated with system 1000. In FIG. 6, an approver may enable the proxy approval feature by sending an email to the system 1000 informing the system 1000 to allow an approval. The email, for example, may allow the system 1000 to approve a requisition based on at least one of the following details: requester's name, business unit, category, supplier name, item description, unit price, total amount. The approver may also provide dates for proxy approval. This information may thereafter be stored on the system 1000. Referring to FIG. 6, when a user/requisitioner 100 sends a requisition with specified details for approval, the system 1000 may automatically verify if there is a matching proxy approval setup based on the email of the approver. If the requisition matches the Proxy setup information the request gets approved. Proxy set up may expire based on the expiry date set by an approver.

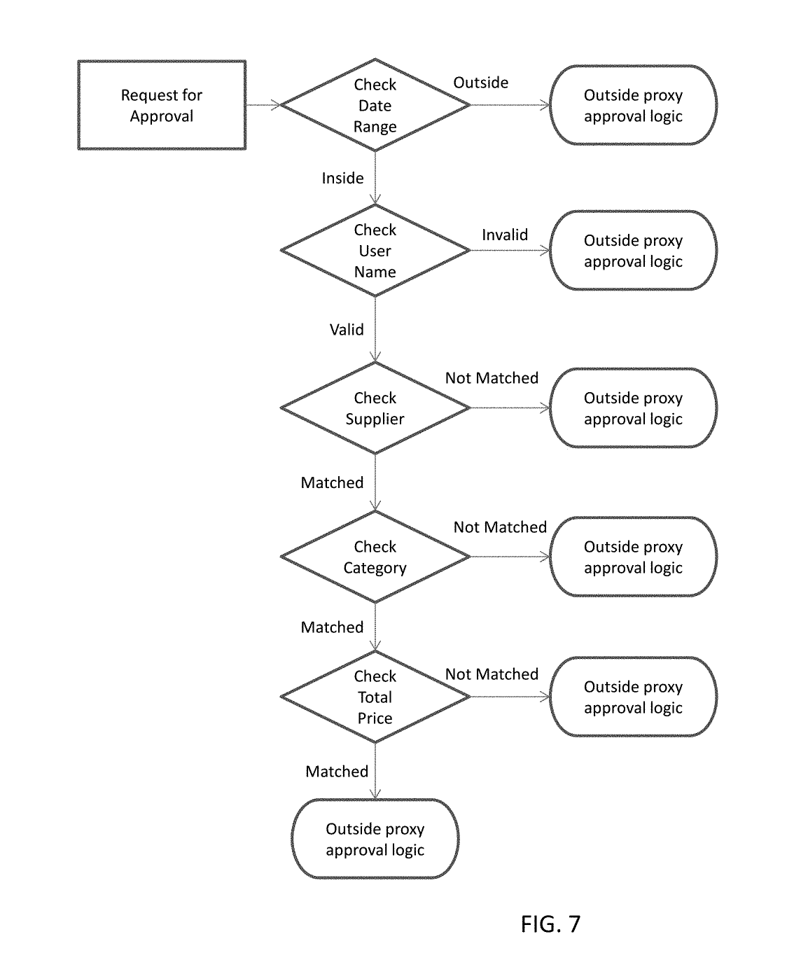

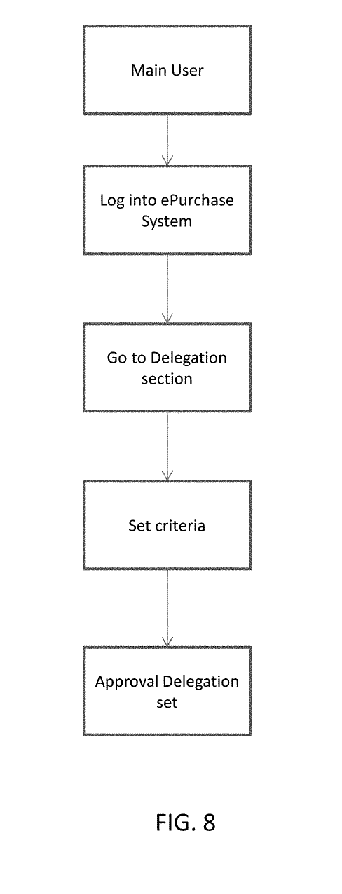

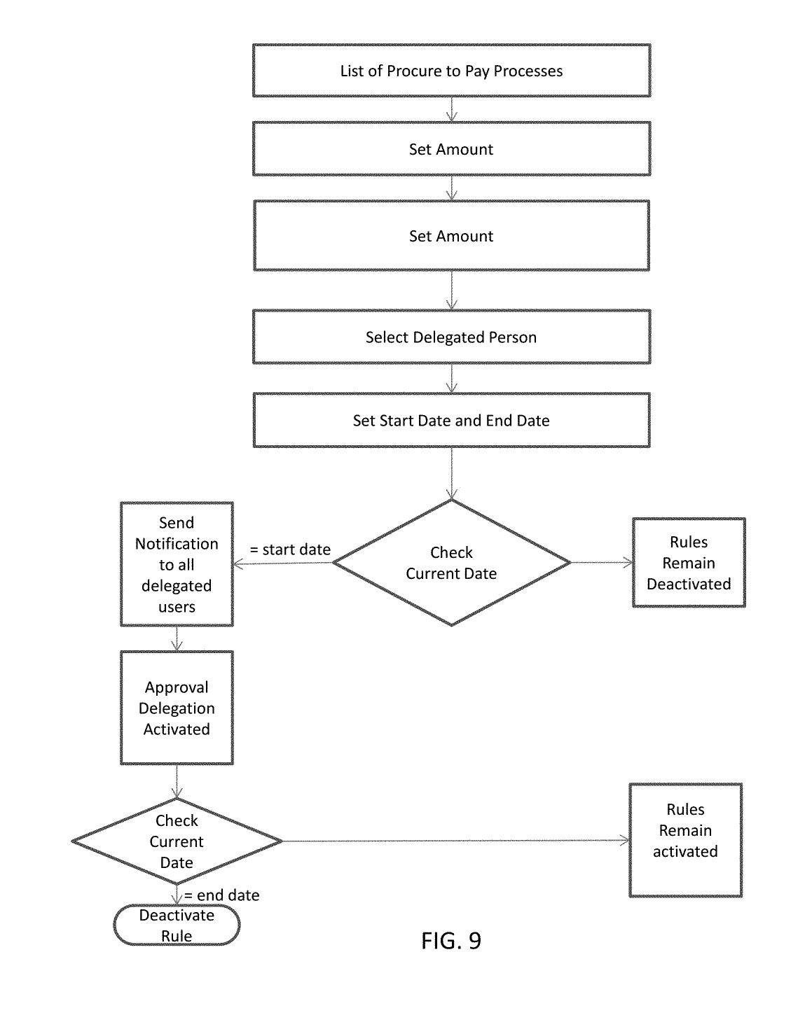

FIG. 6 describes the high level process flow of the proxy approval system. In this nonlimiting example, requisition approver will send the email to the system 1000. Data from the email will come to the Approval Engine 200 and the Approval Engine 200 will be updated with the conditions provided in the email by the Requisition approver. The user/requisitioner 100, for his part, will place the requisition. The system 1000 will check whether the requester is placing the requisition for the first time or not. If it is not for the first time then system will reject the approval. If the user request is coming from that user for the first time then the request will proceed further to an Approval matching engine. Within this approval matching engine all the calculations will take place. Approval matching logic has been detailed out in FIG. 7. A validation will be triggered, if it matches with the stored approval then the requisition will be approved else the requisition will be rejected.

Within the approval matching engine 200 the system 1000 will first check the date range, if the date range is within the date range provided by the approver's in email then the system then the system will proceed further. If the date range is not within then date range then it will be outside the proxy approval logic. After that, system 1000 will keep a check on user name, supplier, category, total Price (sequentially on one nonlimiting example embodiment), if all these things are matched with the email provided by the approver then the requisition will be approved else it will be rejected.

Another aspect of example embodiments is the implementation tiered delegation. Tiered approval flow is a system in which a business user can delegate approval for any of the Procure to pay (P2P) related processes, for example, Requisition, Purchase Order, Invoice and Receipt. In this system a single user may set multiple delegation rules as per the business's needs. The system may also be capable of setting delegation rules on various combinations of, for example, Dollar Amount and Category. In example embodiments delegated user/s may be prohibited from setting delegation rules. In one embodiment, a user may log in to the ePurchase system. Within the ePurchase system the user may set the rules for delegation. Based upon the roles and rights provided to the logged in user, authority of delegation may be provided on different Procure to pay processes as mentioned earlier. The first step, in one embodiment, involves a User selecting the process for which he/she wants to set delegation rules.

As the system will be capable of delegation rules based upon dollar amount and category so the user can select either or both of them based upon the business requirement. Dollar amount and category may be optional fields. After completion of these, or except the earlier steps, a user may select a delegated person's name. User may select this using a system component. This is designed so there will be no conflict of user name or User ID. This component will populate the list of available users related to the selected business process.

In example embodiments, the system can have duplicate User names but user IDs will be unique across the system. To define the delegation time window, user may set an effective date (can be termed as start date) and an Expiry date (can be termed as End Date). Once the user is done with all these rules set up, he/she may add the rule. As soon as the system date is equal to the start date the rule will automatically be activated. It will automatically deactivate as per the expiry date provided by the user. In at least one example embodiment, the System will not allow the user to set a rule prior to the current date and the expiry date will be greater than or equal to the current date. In at least one example embodiment an option will be provided so that if the user wants, he/she can deactivate the delegation rule in between the start date and end date. In at least one example embodiment, the system may send notification to all the delegated user/s on both activation and deactivation of the rule/s. The notification may also contain the details about the rule. No user will receive notification related to other users.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the claims.

What is claimed is:

1. A method for managing a requisition, the method comprising:
using an electronic interface to define a first requisition;
checking a name of a requisitioner to determine whether the requisitioner has previously submitted a requisition and, if not, generating a list of approvers, sending the approvers a notification and tracking response times of the approvers after they approved the first requisition, and, if so, fetching approval related data from a historical knowledge base.

2. The method of claim 1, further comprising:
notifying a group of approvers of the first requisition, if the name of the requisitioner was previously submitted.

3. The method of claim 2, further comprising:
calculating best and worst times required for approval, if the name of the requisitioner has previously submitted.

4. The method of claim 3, further comprising:
displaying a list of bottleneck approvers to the requisitioner, if the name of the requisitioner has previously submitted.

5. The method of claim 2, further comprising:
presenting the requisitioner with the option to change approvers.

6. A method for expediting approval of a requisition, the method comprising:
receiving a requisition from a requisitioner through an electronic interface wherein the requisition is processed based on a delegation protocol;
analyzing the requisition and the delegation protocol for assigning a first approver to approve the requisition within a pre-defined delegation time window;
determining if the requisition is approved; and
escalating the requisition to a second approver for approval if the requisition is not approved within the pre-defined delegation time window.

7. The method as claimed in claim 6 further comprising:
devising the delegation protocol based on contents of the requisition.

8. The method as claimed in claim 6 further comprising:
analyzing the delegation protocol to determine the escalation of the requisition from the first approver to the second approver.

9. The method as claimed in claim 6 wherein the delegation protocol is defined by the requisitioner.

10. The method as claimed in claim 6 wherein the delegation protocol is automatically defined by an artificial intelligence based approval system.

11. A method for managing a requisition, the method comprising:
receiving requisition from a requisitioner by an electronic interface;
processing and analyzing contents of the requisition along with information stored in a historical knowledge database by an artificial intelligence AI engine;
generating and displaying a plurality of approvers along with their estimated time for approval wherein the AI engine assigns at least one approver from the list of approvers for approving the requisition; and
receiving a confirmation or alternate selection of the at least one approver from the requisitioner, wherein the AI engine checks credentials of the requisitioner, credentials of the plurality of approvers, content of the requisition for generating the list of approvers.

12. The method as claimed in claim 11 wherein the credentials of the requisitioner includes name and category of requisitioner.

13. The method as claimed in claim 12 wherein the credentials of the requisitioner includes data pertaining to past approved request of the requisitioner.

14. The method as claimed in claim 11 wherein the credentials of the approver include approver name and category of the approver.

15. The method as claimed in claim 14 wherein the credentials of the approver include data pertaining to past approved request by the approver for the requisitioner.

16. The method as claimed in claim 11 wherein the content of the requisition includes information about requisition line item, unit price of an object and total price of the object.

17. The method as claimed in claim 11 further comprising the step of receiving approval to the requisition from the at least one approver.

18. The method of claim 11, further comprising:
checking if contents of the requisition match with credentials of the at least one approver to determine if an auto-approval has been set by the at least one approver for the requisition, wherein the requisition is automatically approved via a proxy email set by the at least one approver.

19. A system with reduced processing time for approval of a requisition, the system comprising:
an electronic interface for receiving a requisition from a requisitioner;
a historical knowledge database for storing information relating to credentials of the requisitioner and credentials of at least one approver; and
a processor coupled to the historical knowledge database, wherein the processor is operable to generate a list of approvers based on contents of the requisition and the information stored in the historical knowledge database.

20. The system as claimed in claim 20 further comprising:
an artificial intelligence (AI) base engine coupled to the processor wherein the AI engine enables the processor to process contents of the requisition, credentials of the requisitioner and credentials of the at least one approver for generating the list of approvers.

21. The system of claim 20 further comprising:
a response solution engine coupled to the processor for automatically approving the requisition via a proxy email set by the at least one approver.

22. The system of claim 20 further comprising an approval time database configured to update an approval time information of the plurality of approvers on a real-time basis.

23. The system of claim 20 further comprising an AI based calculator and assimilation engine for calculating the approval time for the requisition.
